(19) United States
(12) Patent Application Publication
(10) Pub. No.: US 2026/0118788 A1
(43) Pub. Date: Apr. 30, 2026

(54) ELECTROSTATIC CHARGE IMAGE DEVELOPING CARRIER, ELECTROSTATIC CHARGE IMAGE DEVELOPER, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Yasuo KADOKURA, Kanagawa (JP); Moegi IGUCHI, Kanagawa (JP); Yosuke TSURUMI, Kanagawa (JP); Ryo NAGAI, Kanagawa (JP)

(73) Assignee: FUJIFILM Business Innovation Corp., Tokyo (JP)

(21) Appl. No.: 19/004,470

(22) Filed: Dec. 30, 2024

(30) Foreign Application Priority Data
Feb. 8, 2024 (JP) 2024-018070
Jul. 19, 2024 (JP) 2024-116296

(51) Int. Cl. G03G 9/083; G03G 9/093

(52) U.S. Cl. CPC G03G 9/0839; G03G 9/0833; G03G 9/0838; G03G 9/09385; G03G 2215/0607; G03G 2215/0634; G03G 2221/183

(57) ABSTRACT

An electrostatic charge image developing carrier includes magnetic particles and a resin coating layer that coats the magnetic particles, in which the resin coating layer contains inorganic particles, and in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less.

### CROSS-REFERENCE TO RELATED APPLICATIONS

This application is based on and claims priority under 35 USC 119 from Japanese Patent Application No. 2024-116296 filed Jul. 19, 2024 and Japanese Patent Application No. 2024-018070 filed Feb. 8, 2024.

### BACKGROUND

### (i) Technical Field

The present disclosure relates to an electrostatic charge image developing carrier, an electrostatic charge image developer, a process cartridge, an image forming apparatus, and an image forming method.

### (ii) Related Art

As an electrostatic charge image developing carrier, a resin-coated carrier having a resin coating layer on a surface of magnetic particles has been known. As the resin-coated carrier, for example, the followings are disclosed.

JP2022-181065A discloses an electrostatic charge image developing carrier having magnetic particles and a resin layer that contains silica particles having an average particle size of 50 nm or more and 200 nm or less, in which a proportion Si1 of an Si element in a region having a distance of 0.1 μm or more and 0.2 μm or less in an inner direction from a surface of the resin layer and a proportion Si2 of an Si element in a region having a distance of 0.0 μm or more and 0.1 μm or less in a surface direction of the resin layer from a surface of the magnetic particles satisfy the expression 1-1 and the expression 2-1.

$$0.005 \leq Si 1 \leq 2 \qquad Expression 1 - 1$$

$$1 \leq Si 1 / Si 2 \leq 1000 \qquad Expression 2 - 1$$

JP2012-93629A discloses an electrophotographic carrier including a core material and a resin layer coating the core material, in which the expression (1) is satisfied.

$$1 \leq ( S \times r \times D ) / 3 \leq 1.5 \qquad Expression ( 1 )$$

In the expression (1), S represents a BET specific surface area (m²/g) of the electrophotographic carrier, r represents an average particle radius (m) of the electrophotographic carrier, and D represents a density (g/m³) of the electrophotographic carrier.

### SUMMARY

Aspects of non-limiting embodiments of the present disclosure relate to an electrostatic charge image developing carrier in which image density stability in an image to be obtained is excellent, as compared with a case of an electrostatic charge image developing carrier in which a resin coating layer contains inorganic particles, and in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is less than 0.5 atm % or more than 3.0 atm %.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided an electrostatic charge image developing carrier including magnetic particles and a resin coating layer that coats the magnetic particles, in which the resin coating layer contains inorganic particles, and in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit value or lower limit value of a numerical range may be replaced with values described in examples.

In the present disclosure, “A and/or B” is synonymous with “at least one of A or B”. That is, “A and/or B” represents that A alone may be used, B alone may be used, or a combination of A and B may be used.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, in a case where a compound is represented by a structural formula, the compound may be represented by a structural formula in which symbols representing a carbon atom and a hydrogen atom (C and H) in a hydrocarbon group and/or a hydrocarbon chain are omitted.

In the present disclosure, “(meth)acrylic” is an expression including both acrylic and methacrylic, and “(meth)acrylate” is an expression including both acrylate and methacrylate.

In the present disclosure, a “toner” refers to an “electrostatic charge image developing toner”, a “developer” refers to an “electrostatic charge image developer”, and a “carrier” refers to an “electrostatic charge image developing carrier”.

### Electrostatic Charge Image Developing Carrier

The carrier according to the present exemplary embodiment has magnetic particles and a resin coating layer that coats the magnetic particles, and the resin coating layer contains inorganic particles.

In the resin coating layer of the carrier according to the present exemplary embodiment, carbon black is not included in the inorganic particles.

In the carrier according to the present exemplary embodiment, in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less.

In the carrier of the related art, in a case where an image having a low image density is output in a low-temperature and low-humidity environment and then an image having a high image density is output, phenomenon of excessive charging (charge-up) occurs, and phenomenon of a decrease in image density occurs.

In the carrier according to the present exemplary embodiment, since the value of B−A is 0.5 atm % or more and 3.0 atm % or less, in a case where a surface of the carrier is scraped due to stress in the developing device, the inorganic particles are appropriately exposed on the surface, and an effect of more constantly maintaining the image density is exhibited by preventing an abnormal increase or decrease in the charge, and thus image density stability of the image to be obtained is excellent. In particular, the effect is large in a case where an image having a low image density is output in a low-temperature and low-humidity environment, and then an image having a high image density is output.

Hereinafter, the configuration of the carrier according to the present exemplary embodiment will be described in detail.

### Value of B−A

In the carrier according to the present exemplary embodiment, in a case where an element ratio of metals and metalloids, that constitute the inorganic particles contained in the resin coating layer, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less.

From the viewpoint of image density stability of the image to be obtained, the value of B−A is, for example, preferably 0.8 atm % to 2.7 atm %, more preferably 1.0 atm % to 2.5 atm %, and still more preferably 1.2 atm % to 2.3 atm %.

A method of element analysis in the depth direction and a method of measuring the element ratios A and B by X-ray photoelectron spectroscopy (XPS) are as follows.

The carrier is used as a sample of XPS, and elements are analyzed while etching is carried out. The elements to be analyzed are carbon, nitrogen, oxygen, iron, manganese, and metals and metalloids constituting the inorganic particles. In a case where the metals and the metalloids constituting the inorganic particles are unknown, the metals and the metalloids constituting the inorganic particles are specified by performing a total element analysis of the carrier in advance. Examples of the metal element constituting the inorganic particles include aluminum and titanium. Examples of the metalloid element constituting the inorganic particles include silicon, boron, germanium, arsenic, antimony, and tellurium.

A proportion of the total element amount of the metals and the metalloids constituting the inorganic particles to the total element amount of all elements to be analyzed is defined as the element ratio (atm %) of the metals and the metalloids constituting the inorganic particles. That is, the element ratio (atm %) of the metals and the metalloids constituting the inorganic particles is (Total element amount of metals and metalloids constituting inorganic particles)/(Total element amount of carbon, nitrogen, oxygen, iron, manganese, and metals and metalloids constituting the inorganic particles)×100.

The above-described element ratio at 0 seconds of etching is defined as A (atm %) and the element ratio at 300 seconds of etching is defined as B (atm %). The 0 seconds of etching means that etching is not performed.

The above-described XPS is performed with the following device and conditions. The analysis is performed after baseline correction.
XPS device: PHI5000 Versa Probe II (ULVAC-PHI, Inc.)
X-ray source: monochromatic Al-Kα ray
Beam voltage: 15 kV
Emission current: 3 mA
Etching gun: argon gas cluster ion gun
Degree of vacuum: 1×10⁻⁵ Pa to 1×10⁻⁶ Pa
Pass Energy: 23.5 eV
Sweep region: 300 m×300 m
Time Per Step: 50 seconds
Cycle: 5 times
Sweep: 10 times

In a case of analyzing the carrier contained in the developer, examples of a method of separating the carrier from the developer include a method of removing the toner from the developer by air blowing using any mesh.

### Value of Element Ratio A

From the viewpoint of image density stability, a value of the element ratio A is, for example, preferably 2.0 atm % or more and 10.0 atm % or less, more preferably 2.5 atm % or more and 8.0 atm % or less, and still more preferably 3.0 atm % or more and 6.0 atm % or less.

In a case where the element ratio A is within the above-described range, the abrasion due to the stress in the developing device is suppressed by formation of fine unevenness on the carrier surface by the inorganic particles and the carrier surface being appropriately hard by the inorganic particles, and as a result, the image density is stabilized.

### Value of Element Ratio B

From the viewpoint of image density stability, a value of the element ratio B is, for example, preferably 3.5 atm % or more and 12.0 atm % or less, more preferably 4.3 atm % or more and 9.8 atm % or less, and still more preferably 4.8 atm % or more and 7.8 atm % or less.

In a case where the element ratio B is 3.5 atm % or more, the amount of the inorganic particles exposed in a case where the carrier surface is scraped due to the stress in the developing device is not too small, the charging is not excessively increased, and as a result, the image density is stabilized.

In a case where the element ratio B is 12.0 atm % or less, the amount of the inorganic particles exposed in a case where the carrier surface is scraped due to the stress in the developing device is not too large, the charging is not excessively decreased, and as a result, the image density is stabilized.

### Method of Controlling Value of B−A

The value of B−A can be controlled, for example, by utilizing a sedimentation phenomenon of particles and/or Brazil nut phenomenon in a case of forming the resin coating layer.

The sedimentation phenomenon of particles is a phenomenon in which a sedimentation rate of the particles changes depending on a particle size and a shape of the particles, a density difference and an affinity between the particles and a dispersion medium, a density difference and an affinity between the particles and other components, a particle concentration, and the like. In general, in a case where the particle size of the particles in a liquid is smaller and the density of the particles is higher, the sedimentation rate of the particles is higher. The Brazil nut phenomenon is a phenomenon in which, in a case where a collection of a plurality of types of particles having different particle sizes is vibrated, particles having a large particle size rise.

In a case where the resin coating layer is formed by a wet manufacturing method, the particles can freely move in the liquid in which the resin is dissolved, so that the above-described phenomenon can be utilized.

Using the above-described phenomenon, the value of B−A is controlled by the material, the particle size, the density, and/or the concentration of the inorganic particles, the presence or absence of other particles, the type of the resin of the resin coating layer, the conditions for forming the resin coating layer, and the like.

In a case where the particle size of the inorganic particles is in an appropriate range, the inorganic particles are likely to be appropriately unevenly distributed on the lower side of the resin coating layer. In a case where particles having a particle size larger than the particle size of the inorganic particles are used in combination as the other particles, the inorganic particles are more likely to be unevenly distributed on the lower side of the resin coating layer.

In a case where the other particles are particles having a lower density than the inorganic particles and/or particles having a different polarity, the inorganic particles are more likely to be unevenly distributed on the lower side of the resin coating layer. In a case where the concentration of the inorganic particles is in an appropriate range, the inorganic particles are likely to be appropriately unevenly distributed on the lower side of the resin coating layer. Even in a case where the concentration of the other particles is in an appropriate range, the inorganic particles are likely to be appropriately unevenly distributed on the lower side of the resin coating layer.

### Resin Coating Layer

### Resin

The carrier according to the present exemplary embodiment has a resin coating layer on a surface of the magnetic particles.

Examples of a resin configuring the resin coating layer include a styrene acrylic acid copolymer; a polyolefin-based resin such as polyethylene or polypropylene; a polyvinyl-based or polyvinylidene-based resins such as polystyrene, an acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof, a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

One kind of each of these resins may be used alone, or two or more kinds of these resins may be used in combination.

From the viewpoint of controlling the value of B−A and viewpoint of image density stability, for example, the resin coating layer preferably contains an acrylic resin having an aliphatic cyclic structure and an amino group, and more preferably contains an acrylic resin that has a constitutional unit having an aliphatic cyclic structure and a constitutional unit having an amino group.

As the aliphatic cyclic structure, for example, a cycloalkyl group is preferable, and a cyclohexyl group is more preferable.

Examples of the acrylic resin having a cyclohexyl group include a homopolymer of a (meth)acrylic monomer having a cyclohexyl group and a copolymer of a (meth)acrylic monomer having a cyclohexyl group and another monomer. Examples of the (meth)acrylic monomer having a cyclohexyl group include cyclohexyl acrylate and cyclohexyl methacrylate.

As the constitutional unit having an aliphatic cyclic structure, for example, a constitutional unit derived from cyclohexyl (meth)acrylate is preferable.

From the viewpoint of image density stability, for example, the acrylic resin that has a constitutional unit having an aliphatic cyclic structure preferably contains 80% by mass or more of the constitutional unit having an aliphatic cyclic structure.

As the (meth)acrylic monomer having an amino group, for example, dialkylaminoalkyl (meth)acrylate is preferable, and dimethylaminoethyl (meth)acrylate is more preferable.

From the viewpoint of image density stability, for example, the acrylic resin that has a constitutional unit having an amino group preferably contains 0.05% by mass or more and 5% by mass or less of the constitutional unit having an amino group, and more preferably contains 0.1% by mass or more and 2% by mass or less of the constitutional unit having an amino group.

### Inorganic Particles

The resin coating layer contains inorganic particles.

Examples of the inorganic particles include particles of a metal compound such as silica (silicon dioxide), titania (titanium oxide), alumina (aluminum oxide), zinc oxide, tin oxide, barium sulfate, aluminum borate, potassium titanate, antimony-doped tin oxide, indium-doped tin oxide, and zinc oxide-doped aluminum; particles of a metal such as gold, silver, and copper; and resin particles coated with a metal.

One kind of inorganic particles may be used alone, or two or more kinds of inorganic particles may be used in combination.

As the inorganic particles, from the viewpoint of excellent dispersibility in the resin and viewpoint of exhibiting the effect of preventing the abnormal increase or decrease in the charge by being appropriately exposed on the surface, for example, at least one selected from the group consisting of silica particles, titania particles, and alumina particles is preferable, and silica particles are more preferable.

From the viewpoint of image density stability, an average primary particle size of the inorganic particles is, for example, preferably 1 nm or more and 100 nm or less, more preferably 5 nm or more and 60 nm or less, still more preferably 5 nm or more and 40 nm or less, even more preferably 6 nm or more and 30 nm or less, and particularly preferably 7 nm or more and 20 nm or less.

In a case where the average primary particle size of the inorganic particles is 1 nm or more, the inorganic particles are less likely to aggregate with each other in a case of forming the resin coating layer, and as a result, the inorganic particles are likely to be unevenly distributed on the lower side of the resin coating layer.

In a case where the average primary particle size of the inorganic particles is 100 nm or less, the exposure on the surface of the resin coating layer is suppressed.

In the present exemplary embodiment, the primary particle size of the inorganic particles is a diameter of a circle having the same area as the primary particle image (so-called equivalent circle diameter), and the average primary particle size of the inorganic particles is a particle size at which a cumulative percentage from the small diameter side in the number-based distribution of the primary particle diameters is 50%. The primary particle size of the inorganic particles is determined by performing image analysis on at least 300 inorganic particles.

The inorganic particles contained in the resin coating layer may be simply inorganic particles or may be particles obtained by performing a hydrophobic treatment on a surface of the inorganic particles (may be referred to as “base particles”). From the viewpoint that the effect of preventing the aggregation of the inorganic particles is large, the affinity with the resin of the resin coating layer is increased, and the effect of preventing the abnormal increase or decrease in the charge is likely to be exhibited by being appropriately exposed on the surface, for example, inorganic particles that subjected to a surface treatment are preferable, and inorganic particles having a surface subjected to a hydrophobization treatment are more preferable.

The surface treatment of the inorganic particles is performed, for example, by preparing a treatment liquid obtained by mixing the silicon-containing organic compound that is a hydrophobizing agent with a solvent, mixing the inorganic particles with the treatment liquid under stirring, and further continuing the stirring. After the surface treatment, for the purpose of removing the solvent in the treatment liquid, a drying treatment is performed.

Examples of the silicon-containing organic compound used in the surface treatment for the inorganic particles include an alkoxysilane compound, a silazane compound, and a silicone oil. Among these, from the viewpoint of obtaining an effect of improving the dispersibility of the inorganic particles and preventing the aggregation due to the appropriate three-dimensional disorder, and from the viewpoint of easily exhibiting the effect of preventing the abnormal increase or decrease in the charge when the inorganic particles are appropriately present on the surface, for example, an alkoxysilane compound or a silazane compound is preferable, and a silazane compound is more preferable.

Examples of the alkoxysilane compound used in the hydrophobization treatment of the surface of the inorganic particles include tetramethoxysilane, tetraethoxysilane; methyltrimethoxysilane, ethyltrimethoxysilane, propyltrimethoxysilane, butyltrimethoxysilane, hexyltrimethoxysilane, n-octyltrimethoxysilane, decyltrimethoxysilane, dodecyltrimethoxysilane, vinyltriethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane; dimethyldimethoxysilane, dimethyldiethoxysilane, methylvinyldimethoxysilane, methylvinyldiethoxysilane, diphenyldimethoxysilane, diphenyldiethoxysilane; and trimethylmethoxysilane and trimethylethoxysilane.

Examples of the silazane compound used in the hydrophobization treatment of the surface of the inorganic particles include dimethyldisilazane, trimethyldisilazane, tetramethyldisilazane, pentamethyldisilazane, and hexamethyldisilazane.

Examples of the silicone oil used in the surface treatment for the inorganic particles include silicone oils such as dimethylpolysiloxane, diphenylpolysiloxane, and phenylmethylpolysiloxane; and reactive silicone oils such as amino-modified polysiloxane, epoxy-modified polysiloxane, carboxyl-modified polysiloxane, carbinol-modified polysiloxane, fluorine-modified polysiloxane, methacryl-modified polysiloxane, mercapto-modified polysiloxane, and phenol-modified polysiloxane.

The solvent used for preparing the treatment liquid is, for example, preferably an alcohol (for example, methanol, ethanol, propanol, or butanol) in a case where the silicon-containing organic compound is an alkoxysilane compound or a silazane compound, or preferably hydrocarbons (for example, benzene, toluene, normal hexane, and normal heptane) in a case where the silicon-containing organic compound is a silicone oil.

In the treatment liquid, a concentration of the silicon-containing organic compound is, for example, preferably 1% by mass or more and 50% by mass or less, more preferably 5% by mass or more and 40% by mass or less, and still more preferably 10% by mass or more and 30% by mass or less.

The amount of the silicon-containing organic compound used in the surface treatment is, for example, preferably 1 part by mass or more and 50 parts by mass or less, more preferably 5 parts by mass or more and 40 parts by mass or less, and still more preferably 5 parts by mass or more and 30 parts by mass or less with respect to 100 parts by mass of the inorganic particles.

A content of the inorganic particles in the resin coating layer is, for example, preferably 15% by mass or more and 35% by mass or less, more preferably 17% by mass or more and 30% by mass or less, and still more preferably 20% by mass or more and 25% by mass or less with respect to the total mass of the resin coating layer. In a case where the content of the inorganic particles is within the above-described range, the inorganic particles are likely to be appropriately unevenly distributed on the lower side of the resin coating layer.

A ratio (element ratio A/content of inorganic particles; atm %/% by mass) of the amount of the inorganic particles on the carrier surface (element ratio A, atm %) to the content of the inorganic particles in the resin coating layer (% by mass) is, for example, preferably 0.05 or more and 0.60 or less, more preferably 0.08 or more and 0.40 or less, and still more preferably 0.10 or more and 0.30 or less. In a case where the ratio of the amount of the inorganic particles on the carrier surface (element ratio A, atm %) to the content of the inorganic particles in the resin coating layer (% by mass) is within the above-described range, the carrier surface is appropriately hardened by the inorganic particles, and the inorganic particles are appropriately unevenly distributed on the lower side of the resin coating layer.

### Resin Particles

From the viewpoint of image density stability, for example, the resin coating layer preferably contains resin particles.

Examples of the resin particles include particles of a polymerized(meth)acrylic resin containing dimethylaminoethyl (meth)acrylate, dimethyl acrylamide, acrylonitrile, and the like; an amino resin such as urea, melamine, guanamine, or aniline; an amide resin; a urethane resin; and a copolymer of the above resin; and the like. One kind of resin particles may be used alone, or two or more kinds of resin particles may be used in combination.

From the viewpoint of image density stability, the resin particles are, for example, preferably at least one selected from the group consisting of acrylic resin particles, amino resin particles, and urethane resin particles, more preferably amino resin particles, and still more preferably melamine resin particles.

Since the melamine resin particles have a polarity different from polarity of the inorganic particles, it is considered that the Brazil nut phenomenon works more.

From the viewpoint of image density stability, an average primary particle size of the resin particles is, for example, preferably 100 nm or more and 400 nm or less, and more preferably 150 nm or more and 350 nm or less.

In a case where the average primary particle size of the resin particles is within the above-described range, the difference in particle size with the inorganic particles is appropriate, and the inorganic particles are likely to be unevenly distributed on the lower side of the resin coating layer.

In the present exemplary embodiment, the primary particle size of the resin particles is a diameter of a circle having the same area as the primary particle image (so-called equivalent circle diameter), and the average primary particle size of the resin particles is a particle size at which a cumulative percentage from the small diameter side in the number-based distribution of the primary particle diameters is 50%. The primary particle size of the resin particles is determined by performing image analysis on at least 300 resin particles.

A value of a ratio D1/D2 of an average primary particle size D1 of the inorganic particles contained in the resin coating layer to an average primary particle size D2 of the resin particles is, for example, preferably 0.01 or more and 0.15 or less, and more preferably 0.02 or more and 0.10 or less.

In a case where the value of the ratio D1/D2 is within the above-described range, the difference in particle size between the inorganic particles and the resin particles is appropriate, and the inorganic particles are likely to be unevenly distributed on the lower side of the resin coating layer.

A value of a density ratio of the inorganic particles to the resin particles (density of inorganic particles/density of resin particles) is, for example, preferably 1.0 or more and 5.0 or less. In a case where the density ratio is within the above-described range, a difference in sedimentation degree in the liquid is likely to occur in a case where the resin coating layer is formed by the wet manufacturing method, and the inorganic particles are likely to be arranged on the lower side of the resin coating layer.

From the viewpoint of image density stability, a content of the resin particles in the resin coating layer is, for example, preferably lower than the content of the inorganic particles.

From the viewpoint of image density stability, the content of the resin particles contained in the resin coating layer is, for example, preferably 5% by mass or more and 30% by mass or less, more preferably 6% by mass or more and 20% by mass or less, and still more preferably 7% by mass or more and 15% by mass or less with respect to the total mass of the resin coating layer.

### Carbon Black

From the viewpoint of image density stability, for example, the resin coating layer preferably contains carbon black.

From the viewpoint of image density stability, an average primary particle size of the carbon black is, for example, preferably 10 nm or more and 70 nm or less, more preferably 20 nm or more and 60 nm or less, and still more preferably 30 nm or more and 50 nm or less.

A value of a ratio D1/D3 of the average primary particle size D1 of the inorganic particles contained in the resin coating layer to an average primary particle size D3 of the carbon black is, for example, preferably 0.1 or more and 1.0 or less.

In a case where the value of the ratio D1/D3 is within the above-described range, the difference in particle size between the inorganic particles and the carbon black is appropriate, the Brazil nut phenomenon is likely to be exhibited, and the carbon black floats on the upper side of the resin coating layer in a case of forming the resin coating layer by the wet manufacturing method, and as a result, the inorganic particles are likely to be arranged on the lower side of the resin coating layer.

A value of a density ratio of the inorganic particles to the carbon black (density of inorganic particles/density of carbon black) is, for example, preferably 1.0 or more and 5.0 or less. In a case where the density ratio is within the above-described range, a difference in sedimentation degree in the liquid is likely to occur in a case where the resin coating layer is formed by the wet manufacturing method, and the inorganic particles are likely to be arranged on the lower side of the resin coating layer.

From the viewpoint of image density stability, a content of the carbon black in the resin coating layer is, for example, preferably lower than the content of the inorganic particles in the resin coating layer.

From the viewpoint of image density stability, the content of the carbon black in the resin coating layer is, for example, preferably lower than the content of the resin particles in the resin coating layer.

From the viewpoint of image density stability, the content of the carbon black contained in the resin coating layer is, for example, preferably 0.5% by mass or more and 15% by mass or less, more preferably 1% by mass or more and 13% by mass or less, and still more preferably 2% by mass or more and 10% by mass or less with respect to the total mass of the resin coating layer.

From the viewpoint of image density stability, for example, the resin coating layer preferably contains silica particles and melamine resin particles, and more preferably contains silica particles, carbon black, and melamine resin particles.

### Method of Forming Resin Coating Layer

Examples of a method of forming the resin coating layer on the surface of the magnetic particles include a wet manufacturing method and a dry manufacturing method. The wet manufacturing method is a manufacturing method using a solvent that dissolves or disperses the resin constituting the resin coating layer, and for example, the wet manufacturing method is preferred from the viewpoint that the arrangement of the inorganic particles can be controlled by using the sedimentation phenomenon or the Brazil nut phenomenon.

Specifically, examples of the wet manufacturing method include a dipping method of dipping the magnetic particles in a resin solution for forming a resin coating layer; a spray method of spraying the resin solution for forming a resin coating layer to the surface of the magnetic particles; a fluidized bed method of spraying the resin solution for forming a resin coating layer to the magnetic particles that are in a state of being fluidized in a fluidized bed; and a kneader coater method of mixing the magnetic particles with the resin solution for forming a resin coating layer in a kneader coater and removing solvents.

The resin solution for forming the resin coating layer used in the wet manufacturing method is prepared by dissolving or dispersing a resin and other components in a solvent. The solvent is not particularly limited as long as the solvent dissolves or disperses the resin, and for example, aromatic hydrocarbons such as toluene and xylene; ketones such as acetone and methyl ethyl ketone; ethers such as tetrahydrofuran and dioxane; and the like are used.

In Examples described later, the resin coating layer is formed a plurality of times by the wet manufacturing method, but the method of forming the resin coating layer is not limited thereto.

A thickness of the resin coating layer is, for example, preferably 0.5 μm or more and 2.0 μm or less, and more preferably 0.7 μm or more and 1.4 μm or less.

### Magnetic Particles

The magnetic particles are not particularly limited, and known magnetic particles used as a core material of the carrier are applied. Specific examples of the magnetic particles include particles of a magnetic metal such as iron, nickel, and cobalt; particles of a magnetic oxide such as ferrite and magnetite; resin-impregnated magnetic particles in which a porous magnetic powder is impregnated with a resin; and magnetic powder-dispersed resin particles in which a magnetic powder is dispersed in a resin.

As the magnetic particles in the present exemplary embodiment, for example, ferrite particles are suitable.

In the present exemplary embodiment, for example, it is preferable that the ferrite particles contain at least one compound selected from calcium oxide and strontium oxide. It is presumed that calcium oxide and strontium oxide are likely to be contained in the surface of the ferrite particles, and in a case where a calcium element or a strontium element is present within the surface of the ferrite particles, leakage of charge from the ferrite particles may be suppressed, that may allow the carrier surface to be charged to a high level. Such a carrier inhibits a toner from being charged to a low level in a developing device. As a result, the fogging is further suppressed, and fine line reproducibility is improved (for example, thickening, crushing, or blurring of fine lines is suppressed). The present effect is markedly exhibited in a case where high-concentration and high-density monochromatic images are repeatedly formed at a high speed and then low-density images of the same color are formed.

In the present exemplary embodiment, for example, the ferrite particles preferably contain at least one compound selected from calcium oxide and strontium oxide, and the total content of a calcium element and a strontium element is, for example, preferably 0.1% by mass or more and 2.0% by mass or less with respect to the total mass of the ferrite particles. In a case where the total content of the calcium element and the strontium element is 0.1% by mass or more with respect to the entire ferrite particles, charge leakage from the ferrite particles is efficiently suppressed. In a case where the total content of the calcium element and the strontium element is 2.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the total content of the calcium element and the strontium element with respect to the entire ferrite particles is, for example, preferably 0.1% by mass or more and 2.0% by mass or less, more preferably 0.2% by mass or more and 1.5% by mass or less, and still more preferably 0.5% by mass or more and 1.2% by mass or less.

In the present exemplary embodiment, the ferrite particles contain calcium oxide, and a content of the calcium element is, for example, preferably 0.2% by mass or more and 2.0% by mass or less with respect to the total mass of the ferrite particles. In a case where the content of the calcium element is 0.2% by mass or more with respect to the entire ferrite particles, the charge leakage from the ferrite particles is efficiently suppressed. In a case where the total content of the calcium element is 2.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the content of the calcium element with respect to the entire ferrite particles is, for example, preferably 0.2% by mass or more and 2.0% by mass or less, more preferably 0.5% by mass or more and 1.5% by mass or less, and still more preferably 0.5% by mass or more and 1.0% by mass or less.

In the present exemplary embodiment, the ferrite particles contain strontium oxide, and a content of the strontium element is, for example, preferably 0.1% by mass or more and 1.0% by mass or less with respect to the total mass of the ferrite particles. In a case where the content of the strontium element is 0.1% by mass or more with respect to the entire ferrite particles, the charge leakage from the ferrite particles is efficiently suppressed. In a case where the total content of the strontium element is 1.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the content of the strontium element with respect to the entire ferrite particles is, for example, preferably 0.1% by mass or more and 1.0% by mass or less, more preferably 0.4% by mass or more and 1.0% by mass or less, and still more preferably 0.5% by mass or more and 0.8% by mass or less.

The contents of the calcium element and the strontium element contained in the ferrite particles are measured by X-ray fluorescence analysis. The X-ray fluorescence analysis is performed on the ferrite particles by the following method.

Using an X-ray fluorescence spectrometer (XRF1500, manufactured by Shimadzu Corporation) under the conditions of X-ray output: 40 V/70 mA, measurement area: diameter of 10 mm, and measurement time: 15 minutes, qualitative analysis and quantitative analysis are performed. The element to be analyzed is selected based on the element detected by the qualitative analysis. Iron (Fe), manganese (Mn), magnesium (Mg), calcium (Ca), strontium (Sr), oxygen (O), and carbon (C) are generally selected. A mass proportion (%) of each element is calculated with reference to the separately created calibration curve data.

A volume-average particle size of the magnetic particles is, for example, preferably 20 μm or more and 50 μm or less, more preferably 25 μm or more and 45 μm or less, and still more preferably 30 μm or more and 40 μm or less.

As for a magnetic force of the magnetic particles, a saturation magnetization of the magnetic particles in a magnetic field of 3,000 Oe is 50 emu/g or more, for example, preferably 60 emu/g or more. The saturation magnetization is measured using a vibrating sample magnetometer VSMP10-15 (TOEI INDUSTRY CO., LTD.). The measurement sample is packed in a cell having an inner diameter of 7 mm and a height of 5 mm and set in the aforementioned magnetometer. For the measurement, a magnetic field is applied and swept up to 3,000 Oe. Next, the applied magnetic field is reduced, and a hysteresis curve is created on recording paper. Saturation magnetization, residual magnetization, and coercive force are obtained from the data of the curve.

An electrical volume resistance (volume resistivity) of the magnetic particles is 1×10⁵ Ω·cm or more and 1×10⁹ Ω·cm or less, for example, preferably 1×10⁷ Ω·cm or more and 1×10⁹ Ω·cm or less.

The electrical volume resistance (Ω·cm) of the magnetic particles is measured as follows. A measurement target is placed flat on the surface of a circular jig on which a 20 cm² electrode plate is disposed, such that the measurement target has a thickness of approximately 1 mm or more and 3 mm or less and forms a layer. The above-described 20 cm² electrode plate is placed on the layer such that the layer is sandwiched between the electrode plates. In order to eliminate voids between measurement targets, a load of 4 kg is applied onto the electrode plates arranged on the layer, and then the thickness (cm) of the layer is measured. Both the upper and lower electrodes of the layer are connected to an electrometer and a high-voltage power supply device. A high voltage is applied to both electrodes such that an electric field of 103.8 V/cm is generated, and the current value (A) flowing at this time is read. The volume resistivity is measured in an environment at a temperature of 20° C. and a humidity of 50% RH. An expression for calculating the electrical volume resistance (Ω·cm) of the measurement target is as follows.

$$R = E \times 20 / ( I - {I}_{0} ) / L$$

In the above expression, R represents an electrical volume resistance (Ω·cm) of the measurement target, E represents an applied voltage (V), I represents a current value (A), I₀ represents a current value (A) at an applied voltage of 0 V, and L represents a thickness of the layer (cm). The coefficient of 20 represents an area (cm²) of the electrode plate.

### Characteristics of Carrier

A volume-average particle size of the carrier is, for example, preferably 20 μm or more and 52 μm or less, more preferably 25 μm or more and 47 μm or less, and still more preferably m or more and 42 μm or less.

A volume-average particle size of the carrier is a particle size at which a cumulative percentage from the small diameter side in the volume-based particle size distribution is 50%. The particle size distribution of the carrier is measured with a laser diffraction/scattering type particle size distribution analyzer.

In a case of analyzing the carrier contained in the developer, examples of a method of separating the carrier from the developer include a method of removing the toner from the developer by air blowing using any mesh.

As for a magnetic force of the carrier, a saturation magnetization of the carrier in a magnetic field of 1,000 Oe is 40 emu/g or more, for example, preferably 50 emu/g or more. The measurement of the saturation magnetization described above is performed by sweeping up to a maximum of 1,000 Oe in the same manner as the measurement of the saturation magnetization of the magnetic particles.

A volume electrical resistance (25° C.) of the carrier is 1×10⁷ Ω·cm or more and 1×10¹⁵ Ω·cm or less, for example, preferably 1×10⁸ Ω·cm or more and 1×10⁴ Ω·cm or less and more preferably 1×10⁸ Ω·cm or more and 1×10¹¹ Ω·cm or less. The measurement of the volume electrical resistance of the carrier is performed in the same manner as the measurement of the volume electrical resistance of the magnetic particles.

An exposed proportion of the magnetic particles on the surface of the carrier is, for example, preferably 2% or more and 20% or less, more preferably 3% or more and 15% or less, and still more preferably 4% or more and 12% or less.

The exposed proportion of the magnetic particles on the surface of the carrier is determined by X-ray photoelectron spectroscopy (XPS) from the following method.

A target carrier and magnetic particles obtained by removing the resin coating layer from the target carrier are prepared. Examples of a method of removing the resin coating layer from the carrier include a method of removing the resin coating layer by dissolving resin components with an organic solvent, and a method of removing the resin coating layer by heating the carrier to approximately 800° C. to eliminate the resin components. The carrier and the magnetic particles excluding the resin coating layer are each used as a measurement sample, Fe (atomic %) is quantified by XPS, and (Fe of carrier)÷(Fe of magnetic particles)×100 is calculated to obtain the exposed proportion (%) of the magnetic particles.

The exposed proportion of the magnetic particles on the surface of the carrier can be controlled by the amount of the resin used for forming the resin coating layer, and as the amount of the resin relative to the amount of the magnetic particles is larger, the exposed proportion is smaller.

### Electrostatic Charge Image Developer

The developer according to the present exemplary embodiment contains a toner and the carrier according to the present exemplary embodiment.

The developer according to the present exemplary embodiment is prepared by mixing the toner and the carrier according to the present exemplary embodiment at an appropriate formulation proportion. The mixing ratio (mass ratio) between the toner and the carrier, represented by toner:carrier, is, for example, preferably 1:100 to 30:100, and more preferably 3:100 to 20:100.

### Electrostatic Charge Image Developing Toner

As the toner, known toners are used without particular restriction. Examples thereof include a colored toner that contains toner particles containing a binder resin and a colorant, and an infrared-absorbing toner that uses an infrared absorber instead of a colorant. The toner may contain a release agent, various internal additives, external additives, and the like.

### Toner Particles

### Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin, a styrene acrylic resin, or a styrene acrylic modified polyester resin is preferable, and a polyester resin is more preferable.

A glass transition temperature (Tg) of the resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the resin is, for example, preferably 5,000 or more and 1,000,000 or less, and more preferably 7,000 or more and 500,000 or less. A number-average molecular weight (Mn) of the resin is, for example, preferably 2,000 or more and 100,000 or less. The molecular weight distribution Mw/Mn of the resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC HLC-8120GPC (Tosoh Corporation) as a measurement device, TSKgel Super HM-M (diameter: 15 cm, Tosoh Corporation) as a column, and THE as a solvent. The weight-average molecular weight and the number-average molecular weight are calculated using a molecular weight calibration curve plotted using a monodisperse polystyrene standard sample from the measurement results.

The content of the binder resin with respect to the total amount of the toner particles is, for example, preferably 40% by mass or more and 95% by mass or less, more preferably 50% by mass or more and 90% by mass or less, and still more preferably 60% by mass or more and 85% by mass or less.

### Colorant

Examples of the colorant include pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

A content of the colorant is, for example, preferably 1% by mass or more and 30% by mass or less and more preferably 3% by mass or more and 15% by mass or less with respect to the total amount of the toner particles.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Other Additives

Examples of other additives include known additives such as a magnetic material, a charge control agent, and inorganic powder. The additives are incorporated into the toner particles as internal additives.

### Characteristics of Toner Particles

The toner particles may be toner particles that have a single-layer structure or toner particles having a so-called core/shell structure that is configured with a core portion (core particle) and a coating layer (shell layer) coating the core portion. The toner particles having a core/shell structure may, for example, be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The volume-average particle size (D50v) of the toner particles is measured using COULTER MULTISIZER II (Beckman Coulter, Inc.) and using ISOTON-II (Beckman Coulter, Inc.) as an electrolytic solution. For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less. The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, MgSO₄ and SrTiO₃.

The surface of the inorganic particles as an external additive may have undergone, for example, a hydrophobization treatment. The hydrophobization treatment is performed, for example, by dipping the inorganic particles in a hydrophobizing agent. The hydrophobizing agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

The amount of the hydrophobizing agent is, for example, preferably 1 part by mass or more and 30 parts by mass or less with respect to 100 parts by mass of the inorganic particles.

Examples of the external additive also include resin particles (resin particles such as polystyrene, polymethylmethacrylate, and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 10% by mass or less, and more preferably 0.01% by mass or more and 5% by mass or less.

### Manufacturing Method of Toner

The toner is obtained by manufacturing toner particles and then externally adding external additives to the toner particles. The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). These manufacturing methods are not particularly limited, and known manufacturing methods are adopted. Among the above methods, for example, the aggregation and coalescence method may be used for obtaining toner particles.

### Image Forming Apparatus and Image Forming Method

The image forming apparatus and image forming method according to the present exemplary embodiment will be described.

The image forming apparatus according to the present exemplary embodiment includes an image holder, a charging device that charges the surface of the image holder, an electrostatic charge image forming device that forms an electrostatic charge image on the charged surface of the image holder, a developing device that contains an electrostatic charge image developer and develops the electrostatic charge image formed on the surface of the image holder as a toner image by using the electrostatic charge image developer, a transfer device that transfers the toner image formed on the surface of the image holder to the surface of a recording medium, and a fixing device that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed that has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, well-known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning device that cleans the surface of the image holder before charging after the transfer of the toner image; and an apparatus including a charge neutralization device that neutralizes charge by irradiating the surface of the image holder with charge neutralizing light before charging after the transfer of the toner image.

In the case where the image forming apparatus according to the present exemplary embodiment is the intermediate transfer-type apparatus, for example, a configuration is adopted that has an intermediate transfer member with surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

In the image forming apparatus according to the present exemplary embodiment, for example, a portion including the developing device may be a cartridge structure (process cartridge) detachable from the image forming apparatus. As the process cartridge, for example, a process cartridge is suitably used that includes a developing device that contains the electrostatic charge image developer according to the present exemplary embodiment.

An example of the image forming apparatus according to the present exemplary embodiment will be shown below, but the present invention is not limited thereto. Hereinafter, among the parts shown in the drawings, main parts will be described, and others will not be described.

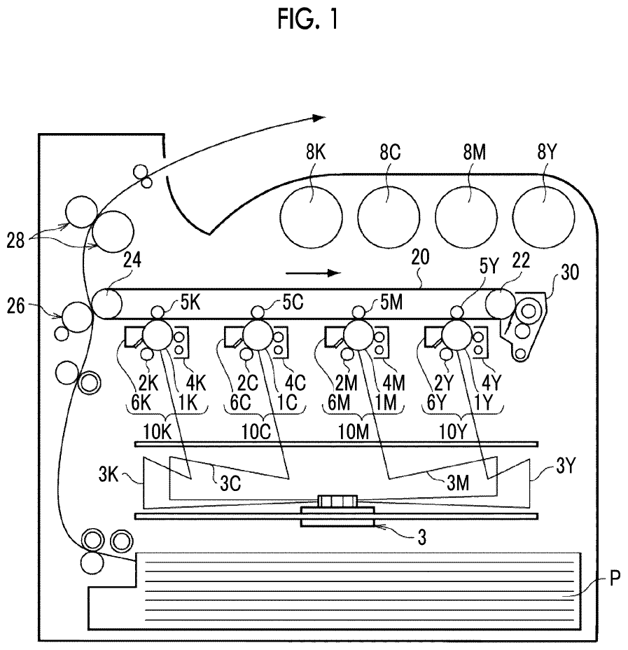

FIG. 1 is a view schematically showing the configuration of the image forming apparatus according to the present exemplary embodiment.

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are detachable from the image forming apparatus.

An intermediate transfer belt (an example of the intermediate transfer member) 20 passing through above the units 10Y, 10M, 10C, and 10K extends under the units. The intermediate transfer belt 20 is looped around a driving roll 22 and a support roll 24, and runs toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the outer peripheral surface of the intermediate transfer belt 20.

Yellow, magenta, cyan, and black toners contained in containers of toner cartridges 8Y, 8M, 8C, and 8K are supplied to developing devices (an example of the developing device) 4Y, 4M, 4C, and 4K of the units 10Y, 10M, 10C, and 10K, respectively.

The first to fourth units 10Y, 10M, 10C, and 10K have the same configuration and operation. Therefore, in the present specification, as a representative, the first unit 10Y will be described that is placed on the upstream side of the running direction of the intermediate transfer belt and forms a yellow image.

The first unit 10Y has a photoreceptor 1Y that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device (an example of the developing device) 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. A bias power supply (not shown in the drawing) for applying a primary transfer bias is connected to primary transfer rolls 5Y, 5M, 5C, and 5K of each unit. Each bias power supply changes the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam, the specific resistance of the portion irradiated with the laser beam changes. From the exposure device 3, the laser beam 3Y is radiated to the surface of the charged photoreceptor 1Y according to the image data for yellow transmitted from the control unit not shown in the drawing. As a result, an electrostatic charge image of the yellow image pattern is formed on the surface of the photoreceptor 1Y

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y is developed as a toner image by the developing device 4Y and visualized.

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. In the first unit 10Y, the transfer bias is set, for example, to +10 μA under the control of the control unit (not shown in the drawing).

On the other hand, the residual toner on the photoreceptor 1Y is removed by a photoreceptor cleaning device 6Y and collected.

The primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt 20, and a secondary transfer roll 26 (an example of the secondary transfer device) disposed on the outer peripheral surface side of the intermediate transfer belt 20. On the other hand, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting device (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of the fixing device), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge

The process cartridge according to the present exemplary embodiment will be described.

The process cartridge according to the present exemplary embodiment includes a developing device that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other devices, such as an image holder, a charging device, an electrostatic charge image forming device, and a transfer device, as necessary.

An example of the process cartridge according to the present exemplary embodiment will be shown below, but the present invention is not limited thereto. Hereinafter, among the parts shown in the drawings, main parts will be described, and others will not be described.

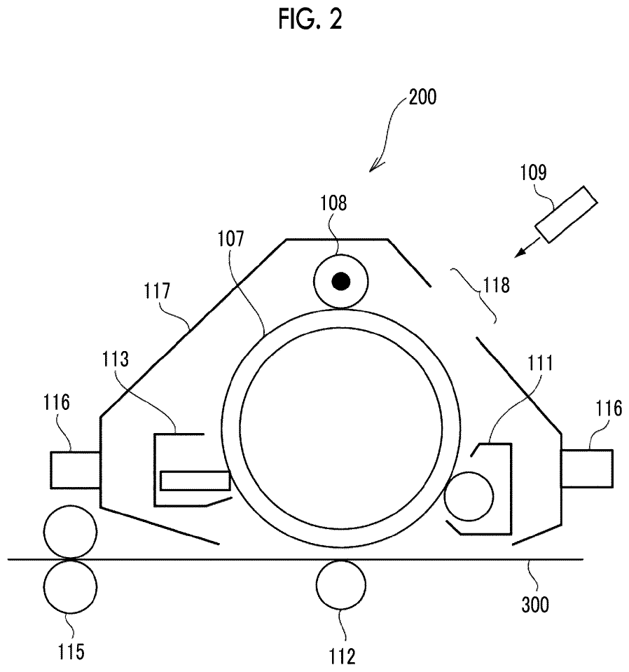

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

### EXAMPLES

Hereinafter, the present exemplary embodiments will be specifically described based on Examples. However, the present exemplary embodiments are not limited to Examples. In the following description, unless otherwise specified, “parts” and “%” are based on mass.

In the following description, the synthesis, the treatment, the production, the test, and the like are carried out at room temperature (25° C.±3° C.) unless otherwise specified.

### Production of Toner

### Preparation of Resin Particle Dispersion (1)

Ethylene glycol (FUJIFILM Wako Pure Chemical Corporation): 37 parts
Neopentyl glycol (FUJIFILM Wako Pure Chemical Corporation): 65 parts
1,9-Nonanediol (FUJIFILM Wako Pure Chemical Corporation): 32 parts
Terephthalic acid (FUJIFILM Wako Pure Chemical Corporation): 96 parts

The above-described materials are put in a flask, the temperature is raised to 200° C. for 1 hour, and after it is confirmed that the inside of the reaction system is uniformly agitated, 1.2 parts of dibutyltin oxide is added. The temperature is raised to 240° C. for 6 hours in a state where the generated water is distilled off, and stirring is continued at 240° C. for 4 hours, thereby obtaining a polyester resin (acid value: 9.4 mgKOH/g, weight-average molecular weight: 13,000, glass transition temperature: 62° C.). The polyester resin in a molten state is transferred to an emulsifying disperser (CAVITRON CD1010, Eurotech Ltd.) at a rate of 100 g/min. Separately, dilute aqueous ammonia having a concentration of 0.37% obtained by diluting the reagent aqueous ammonia with deionized water is put in a tank and transferred to an emulsifying disperser together with the polyester resin at a rate of 0.1 L/min while being heated at 120° C. by a heat exchanger. The emulsifying disperser is operated under the conditions of a rotation speed of a rotor of 60 Hz and a pressure of 5 kg/cm², thereby obtaining a resin particle dispersion (1) having a volume-average particle size of 160 nm and a solid content of 30%.

### Preparation of Resin Particle Dispersion (2)

Decanedioic acid (Tokyo Chemical Industry Co., Ltd.): 81 parts
Hexandiol (FUJIFILM Wako Pure Chemical Corporation): 47 parts

The above-described materials are put in a flask, the temperature is raised to 160° C. for 1 hour, and after it is confirmed that the inside of the reaction system is uniformly agitated, 0.03 parts of dibutyltin oxide is added. While the generated water is distilled off, the temperature is raised to 200° C. for 6 hours, and agitating is continued for 4 hours at 200° C. Thereafter, the reaction solution is cooled, solid-liquid separation is performed, and the solid is dried at a temperature of 40° C. under reduced pressure, thereby obtaining a polyester resin (C1) (melting point: 64° C., weight-average molecular weight: 15,000).
Polyester resin (C1): 50 parts
Anionic surfactant (NEOGEN SC, manufactured by DKS Co. Ltd.): 2 parts
Deionized water: 200 parts

The above-described materials are heated to 120° C., thoroughly dispersed with a homogenizer (ULTRA-TURRAX T50, IKA), and then subjected to a dispersion treatment with a pressure jet-type homogenizer. At a point in time when the volume-average particle size reaches 180 nm, the dispersed resultant is collected, thereby obtaining a resin particle dispersion (2) having a solid content of 20%.

### Preparation of Colorant Particle Dispersion (1)

Cyan pigment (PigmentBlue 15:3, Dainichiseika Color & Chemicals Mfg.Co., Ltd.) : 10 parts
Anionic surfactant (NEOGEN SC, DKS Co. Ltd.): 2 parts
Deionized water: 80 parts

The above-described materials are mixed together and dispersed for 1 hour with a high-pressure impact disperser ULTIMIZER (HJP30006, manufactured by SUGINO MACHINE LIMITED), thereby obtaining a colorant particle dispersion (1) having a volume-average particle size of 180 nm and a solid content of 20%.

### Preparation of Release Agent Particle Dispersion (1)

Paraffin wax (HNP-9, NIPPON SEIRO CO., LTD.): 50 parts
Anionic surfactant (NEOGEN SC, manufactured by DKS Co. Ltd.): 2 parts
Deionized water: 200 parts

The above-described materials are heated to 120° C., thoroughly dispersed with a homogenizer (ULTRA-TURRAX T50, IKA), and then subjected to a dispersion treatment with a pressure jet-type homogenizer. At a point in time when the volume-average particle size reaches 200 nm, the dispersed resultant is collected, thereby obtaining a release agent particle dispersion (1) having a solid content of 20%.

### Production of Toner (1)

Resin particle dispersion (1): 150 parts
Resin particle dispersion (2): 50 parts
Colorant particle dispersion (1): 25 parts
Release agent particle dispersion (1): 35 parts
Polyaluminum chloride: 0.4 parts
Deionized water: 100 parts

The above-described materials are put in a round stainless steel flask, thoroughly mixed and dispersed together by using a homogenizer (ULTRA-TURRAX T50, IKA), and then heated to 48° C. in an oil bath for heating in a state where the inside of the flask is stirred. The internal temperature of the reaction system is kept at 48° C. for 60 minutes, and then 70 parts of the resin particle dispersion (1) is slowly added thereto. Next, the pH is adjusted to 8.0 by using a 0.5 mol/L sodium hydroxide aqueous solution, the flask is then sealed, heated to 90° C. while being continuously stirred with a stirring shaft with a magnetic seal, and kept at 90° C. for 30 minutes. Next, the mixture is cooled at a cooling rate of 5° C./min, subjected to solid-liquid separation, and thoroughly washed with deionized water. Next, the mixture is subjected to solid-liquid separation, redispersed in deionized water at a temperature of 30° C., and stirred and washed at a rotation speed of 300 revolutions per minute (rpm) for 15 minutes. The washing operation is further repeated 6 times, solid-liquid separation is performed at a point in time when the pH of the filtrate reaches 7.54 and the electrical conductivity reaches 6.5 S/cm, and vacuum drying is continued for 24 hours, thereby obtaining toner particles (1) having a volume-average particle size of 5.7 μm.

100 parts of the toner particles (1) and 2.5 parts of silica particles (treated with hexamethyldisilazane for surface hydrophobization, average primary particle size: 40 nm) are mixed with a Henschel mixer to obtain a toner (1).

### Production of Carrier and Developer: Examples 1 to 40 and Comparative Examples 1 to 5

### Production of Ferrite Particles (1)

Fe₂O₃: 1597 parts
Mn(OH)₂: 712 parts
Mg(OH)₂: 116 parts
SrCO₃: 20 parts
CaCO₃: 30 parts

The above-described materials are mixed with each other, a dispersant, water, and zirconia beads having a diameter of 1 mm are added thereto, and the mixture is crushed and mixed using a sand mill. The zirconia beads are separated by filtration, and the filtrate is dried and then temporarily fired using a rotary kiln under the conditions of rotation speed of 20 rpm/temperature of 970° C./2 hours. A dispersant and water are added to the obtained temporarily baked product, and 8 parts of polyvinyl alcohol is further added thereto, followed by pulverization and mixing for 5 hours using a wet ball mill. A volume-average particle size of the obtained pulverized product is 1.2 μm. Next, the product is made into granules having a particle size of 40 μm using a spray dryer. The obtained granulated product is permanently baked using an electric furnace in an oxygen/nitrogen mixed atmosphere having an oxygen concentration of 1% by volume under conditions of temperature of 1,400° C./4 hours. The obtained baked product is crushed and classified to obtain ferrite particles (1). A volume-average particle size of the ferrite particles (1) is 35 μm.

### Preparation of Coating Agent for First Layer and Coating Agent for Second Layer

In the present example, the value of B−A is controlled by a method of forming the resin coating layer a plurality of times. The present example is an example of a method of controlling the value of B−A, but the method of controlling the value of B−A is not limited thereto.

Each component shown in Tables 1 and 2 is put into a sand mill together with glass beads (diameter: 1 mm, the same amount as toluene) at a mass ratio shown in Table 1, and the mixture is stirred at a rotation speed of 190 rpm for 30 minutes to prepare each of a coating agent for a first layer and a coating agent for a second layer.

Details of the abbreviations of the respective components of the coating agents described in Tables 1 and 2 are as follows.
Resin (1): cyclohexyl methacrylate/2-(dimethylamino)ethyl methacrylate copolymer (copolymerization ratio: 97 mol:3 mol)
Resin (2): cyclohexyl methacrylate/methyl methacrylate copolymer (copolymerization ratio: 95 mol:5 mol)
Resin (3): methyl methacrylate polymer
Surface-treated silica (S1): silica particles (HM20S, Tokuyama Corporation, average primary particle size: 12 nm, surface treatment agent: hexamethyldisilazane)
Surface-treated silica (S2): silica particles (NX90S, Nippon Aerosil Co., Ltd., average primary particle size: 22 nm, surface treatment agent: hexamethyldisilazane)
Surface-treated silica (S3): silica particles (RY200, Nippon Aerosil Co., Ltd., average primary particle size: 12 nm, surface treatment agent: hexamethyldisilazane)
Surface-treated silica (S4): silica particles (HM30S, Tokuyama Corporation, average primary particle size: 7 nm, surface treatment agent: hexamethyldisilazane)
Surface-treated silica (S5): silica particles (average primary particle size: 30 nm, dried silica, surface treatment agent: hexamethyldisilazane)
Surface-treated silica (S6): silica particles (average primary particle size: 40 nm, dried silica, surface treatment agent: hexamethyldisilazane)
Surface-treated silica (S7): silica particles (RX50, Nippon Aerosil Co., Ltd., average primary particle size: 65 nm, surface treatment agent: hexamethyldisilazane)
Silica without surface treatment (Sn): silica particles (QS-20, Tokuyama Corporation, average primary particle size: 12 nm)
Surface-treated alumina (A): alumina particles (AluC 805, Nippon Aerosil Co., Ltd., average primary particle size: 22 nm, surface treatment agent: octylsilane)
Surface-treated titania (T): titania particles (T805, Nippon Aerosil Co., Ltd., average primary particle size: 20 nm, surface treatment agent: octylsilane)
Resin particles (M1): melamine resin particles (EPOSTAR FS, manufactured by NIPPON SHOKUBAI CO., LTD., average primary particle size: 250 nm)
Resin particles (M2): melamine resin particles (EPOSTAR SS, manufactured by NIPPON SHOKUBAI CO., LTD., average primary particle size: 70 nm)
Resin particles (M3): melamine resin particles (EPOSTAR S, manufactured by NIPPON SHOKUBAI CO., LTD., average primary particle size: 100 nm)
Resin particles (A1): acrylic resin particles (MP-1441, Soken Chemical & Engineering Co., Ltd., average primary particle size: 150 nm)
Resin particles (A2): acrylic resin particles (MP-2200, Soken Chemical & Engineering Co., Ltd., average primary particle size: 350 nm)
Resin particles (M4): melamine resin particles (EPOSTAR S6, manufactured by NIPPON SHOKUBAI CO., LTD., average primary particle size: 400 nm)
Resin particles (M5): melamine resin particles (EPOSTAR S12, manufactured by NIPPON SHOKUBAI CO., LTD., average primary particle size: 900 nm)
CB: carbon black (VXC72, Cabot Corporation) Production of Carrier (1)

Using a spin coater (Okada Seiko Co., Ltd.), the surface of 1,000 parts of the ferrite particles (1) is coated with the coating agent for a first layer at a rate of 30 g/min in an atmosphere of 70° C. such that the component of the resin coating layer is 15 parts with respect to the ferrite core material. Next, the coating agent for a second layer is applied thereto at a rate of 30 g/min such that the component of the resin coating layer is 15 parts with respect to the ferrite particles (1), and then dried. The dried powder is taken out from the spin coater and crushed using a sieve having an opening size of 75 m, thereby obtaining each of carriers of Examples 1 to 40 and Comparative Examples 1 and 2.

In Comparative Example 3, using a spin coater (Okada Seiko Co., Ltd.), the surface of 1,000 parts of the ferrite particles (1) is coated with the coating agent for a first layer at a rate of 30 g/min in an atmosphere of 70° C. such that the component of the resin coating layer is 30 parts with respect to the ferrite core material, and then dried. The dried powder is taken out from the spin coater and crushed using a sieve having an opening size of 75 m, thereby obtaining a carrier of Comparative Example 3.

### Production of Carrier (2)

### Material (1)

Ferrite particles (1): 1,000 parts
Resin particles of cyclohexyl methacrylate/2-(dimethylamino)ethyl methacrylate copolymer (copolymerization ratio: 97 mol:3 mol): 4.6 parts
Surface-treated silica (S1): 4.0 parts
CB: 0.4 parts
Resin particles (M1): 1.0 part

### Material (2)

Resin particles of cyclohexyl methacrylate/2-(dimethylamino)ethyl methacrylate copolymer (copolymerization ratio: 97 mol:3 mol): 14.7 parts
Surface-treated silica (S1): 2.0 parts
CB: 1.3 parts
Resin particles (M1): 2.0 parts

The above-described material (1) is put in a high-speed mixer with a stirring blade, and stirred at a temperature of 125° C. and a wind speed of 10 m/s for 45 minutes. Next, the above-described material (2) is additionally added thereto, and the mixture is stirred at a temperature of 125° C. and a wind speed of 10 m/s for 45 minutes. A resin coating layer is formed on the surface of the ferrite particles under the action of a mechanical impact force. Next, the wind speed is lowered to 2 m/s, and the temperature is lowered to room temperature to obtain a carrier of Comparative Example 4.

### Production of Carrier (3)

Resin particles of cyclohexyl methacrylate/2-(dimethylamino)ethyl methacrylate copolymer (copolymerization ratio: 97 mol:3 mol): 19.3 parts
Surface-treated silica (S7): 6.0 parts
CB: 1.7 parts
Resin particles (M1): 3.0 parts
Toluene: 386.7 parts

The above-described material is applied to 1,000 parts of the ferrite particles (1) and dried to obtain a carrier of Comparative Example 5. The coating and drying are performed using a fluidized bed type coating device in which the temperature in the fluidized bed is controlled to 70° C.

### Production of Developer

100 parts of the carrier and 6 parts of the toner (1) are charged into a V-blender and stirred for 20 minutes. Thereafter, the mixture is sieved through a sieve having an opening size of 212 μm to obtain each of developers of Examples 1 to 40 and Comparative Examples 1 to 5.

### Measurement of Volume-average Particle Size of Carrier

Using the carrier as a sample, a particle size of the carrier is measured with a laser diffraction/scattering type particle size distribution analyzer (LS Particle Size Analyzer: LS13 320, Beckman Coulter Inc.). A particle diameter (m) at which a cumulative percentage from the small diameter side in the volume-based particle size distribution is 50% is determined.

The volume-average particle size of the carriers of Examples 1 to 40 and Comparative Examples 1 to 5 is 36 μm.

### Elemental Analysis by XPS

Using the carrier as a sample, carbon, nitrogen, oxygen, iron, manganese, and metals and metalloids constituting the inorganic particles are analyzed by XPS using an etching method.

In a case where the inorganic particles are silica particles, carbon, nitrogen, oxygen, iron, manganese, and silicon are analyzed.

In a case where the inorganic particles are alumina particles, carbon, nitrogen, oxygen, iron, manganese, and aluminum are analyzed.

In a case where the inorganic particles are titania particles, carbon, nitrogen, oxygen, iron, manganese, and titanium are analyzed.

An element ratio (atm %) of the metals and the metalloids constituting the inorganic particles to the total element amount of all elements to be analyzed are determined. The element ratio at 0 seconds of etching is defined as A (atm %) and the element ratio at 300 seconds of etching is defined as B (atm %).

The XPS is performed with the following device and conditions. The analysis is performed after baseline correction.
XPS device: PHI5000 Versa Probe II (ULVAC-PHI, Inc.)
X-ray source: monochromatic Al-Kα ray
Beam voltage: 15 kV
Emission current: 3 mA
Etching gun: argon gas cluster ion gun
Degree of vacuum: 1×10⁻⁵ Pa to 1×10⁻⁶ Pa
Pass Energy: 23.5 eV
Sweep region: 300 m×300 m
Time Per Step: 50 seconds
Cycle: 5 times
Sweep: 10 times

### Evaluation of Image Density Stability

The evaluation of each developer is performed using a modified machine of an image forming apparatus Apeos C4030 (FUJIFILM Business Innovation Corp.). Using A4-sized plain paper, one image having an image density of 100% is output in an environment of a temperature of 10° C. and a relative humidity of 15%, 10,000 images having an image density of 0.5% are output, and one image having an image density of 100% is output. An image density of the image having an image density of 100%, as the first image and an image density of the image having an image density of 100%, after outputting 10,000 sheets, are measured with a spectrophotometer X-Rite 938 (X-Rite, Inc.). An image density difference Δ is calculated and classified as follows. For example, it is desirable that the image density difference Δ is smaller.

The results are shown in Table 2.
A: 0.00 or more and less than 0.05
B+: 0.05 or more and less than 0.07
B: 0.07 or more and less than 0.10
C: 0.10 or more and less than 0.15
D: 0.15 or more and less than 0.20
E: 0.20 or more

TABLE 1

| | | | Formulation of coating | | | | | | | Formulation of coating | | | | | | |
|---|---|---|---|---|---|---|---|---|---|---|---|---|---|---|---|---|
| | | Coating | agent for first layer (inside) | | | | | | | agent for second layer (outside) | | | | | | |
| | Carrier | resin | | | | | | Resin | | | | | | | Resin | |
| | Type | Type | | | | | | parti- | | | | | | | parti- | |
| | — | — | Resin | Silica | Alumina | Titania | CB | cles | Toluene | Resin | Silica | Alumina | Titania | CB | cles | Toluene |
| Example 1 | (1) | (1) | 4.6 | 4.0 | — | — | 0.4 | 1.0 | 92.1 | 14.7 | 2.0 | — | — | 1.3 | 2.0 | 294.6 |
| Example 2 | (2) | (1) | 5.1 | 4.1 | — | — | 0.4 | 1.1 | 102.6 | 14.2 | 1.9 | — | — | 1.2 | 1.9 | 284.1 |
| Example 3 | (3) | (1) | 5.7 | 4.2 | — | — | 0.5 | 1.2 | 114.7 | 13.6 | 1.8 | — | — | 1.2 | 1.8 | 272.0 |
| Example 4 | (4) | (1) | 6.4 | 4.3 | — | — | 0.6 | 1.3 | 128.9 | 12.9 | 1.8 | — | — | 1.1 | 1.8 | 257.8 |
| Example 5 | (5) | (1) | 7.3 | 4.4 | — | — | 0.6 | 1.4 | 145.6 | 12.1 | 1.6 | — | — | 1.0 | 1.6 | 241.1 |
| Example 6 | (6) | (1) | 4.1 | 3.9 | — | — | 0.4 | 0.9 | 82.9 | 15.2 | 2.1 | — | — | 1.3 | 2.1 | 303.8 |
| Example 7 | (7) | (1) | 3.7 | 3.9 | — | — | 0.3 | 0.9 | 74.7 | 15.6 | 2.1 | — | — | 1.3 | 2.1 | 312.0 |
| Example 8 | (8) | (1) | 3.4 | 3.8 | — | — | 0.3 | 0.8 | 67.5 | 16.0 | 2.2 | — | — | 1.4 | 2.2 | 319.2 |
| Example 9 | (9) | (1) | 3.1 | 3.8 | — | — | 0.3 | 0.8 | 61.1 | 16.3 | 2.2 | — | — | 1.4 | 2.2 | 325.6 |
| Compar- | (C1) | (1) | 8.3 | 4.5 | — | — | 0.7 | 1.5 | 165.7 | 11.0 | 1.5 | — | — | 1.0 | 1.5 | 221.0 |
| ative | | | | | | | | | | | | | | | | |
| Example 1 | | | | | | | | | | | | | | | | |
| Compar- | (C2) | (1) | 2.8 | 3.8 | — | — | 0.2 | 0.8 | 55.2 | 16.6 | 2.3 | — | — | 1.4 | 2.3 | 331.5 |
| ative | | | | | | | | | | | | | | | | |
| Example 2 | | | | | | | | | | | | | | | | |
| Example 10 | (10) | (1) | 8.9 | 5.6 | — | — | 0.8 | 1.7 | 178.4 | 10.4 | 0.4 | — | — | 0.9 | 1.3 | 208.3 |
| Example 11 | (11) | (1) | 7.6 | 5.3 | — | — | 0.7 | 1.5 | 151.9 | 11.7 | 0.8 | — | — | 1.0 | 1.5 | 234.8 |
| Example 12 | (12) | (1) | 6.3 | 4.8 | — | — | 0.5 | 1.3 | 126.9 | 13.0 | 1.2 | — | — | 1. | 1.7 | 259.8 |
| Example 13 | (13) | (1) | 5.2 | 4.3 | — | — | 0.4 | 1.1 | 103.3 | 14.2 | 1.7 | — | — | 1.2 | 1.9 | 283.4 |
| Example 14 | (14) | (1) | 3.5 | 3.4 | — | — | 0.3 | 0.8 | 70.7 | 15.8 | 2.6 | — | — | 1.4 | 2.2 | 316.0 |
| Example 15 | (15) | (1) | 2.5 | 2.6 | — | — | 0.2 | 0.6 | 50.8 | 16.8 | 3.4 | — | — | 1.4 | 2.4 | 335.9 |
| Example 16 | (16) | (1) | 1.6 | 1.8 | — | — | 0.1 | 0.4 | 32.4 | 17.7 | 4.2 | — | — | 1.5 | 2.6 | 354.3 |
| Example 17 | (17) | (1) | 0.8 | 1.0 | — | — | 0.1 | 0.2 | 15.5 | 18.6 | 5.0 | — | — | 1.6 | 2.8 | 371.2 |
| Example 18 | (18) | (1) | 4.6 | 4.0 | — | — | 0.4 | 1.0 | 92.1 | 14.7 | 2.0 | — | — | 1.3 | 2.0 | 294.6 |
| Example 19 | (19) | (1) | 5.2 | — | 4.5 | — | 0.4 | 1.1 | 103.7 | 15.1 | — | 2.0 | — | 1.3 | 2.0 | 301.5 |
| Example 20 | (20) | (1) | 5.3 | — | — | 4.6 | 0.5 | 1.1 | 105.3 | 15.2 | — | — | 2.1 | 1.3 | 2.1 | 304.4 |
| Example 21 | (21) | (1) | 4.6 | 4.0 | — | — | 0.4 | 1.0 | 92.1 | 14.7 | 2.0 | — | — | 1.3 | 2.0 | 294.6 |
| Example 22 | (22) | (1) | 4.6 | 4.0 | — | — | 0.4 | 1.0 | 92.1 | 14.7 | 2.0 | — | — | 1.3 | 2.0 | 294.6 |
| Example 23 | (23) | (1) | 1.8 | 1.6 | — | — | 0.2 | 0.4 | 36.8 | 19.2 | 2.6 | — | — | 1.6 | 2.6 | 383.0 |
| Example 24 | (24) | (1) | 2.8 | 2.4 | — | — | 0.2 | 0.6 | 55.2 | 17.7 | 2.4 | — | — | 1.5 | 2.4 | 353.6 |
| Example 25 | (25) | (1) | 10.6 | 9.2 | — | — | 0.9 | 2.3 | 211.8 | 5.2 | 0.7 | — | — | 0.4 | 0.7 | 103.1 |
| Example 26 | (26) | (1) | 12.4 | 10.8 | — | — | 1.1 | 2.7 | 248.6 | 2.2 | 0.3 | — | — | 0.2 | 0.3 | 44.2 |
| Example 27 | (27) | (1) | 6.0 | 4.0 | — | — | — | — | 120.0 | 18.0 | 2.0 | — | — | — | — | 360.0 |
| Compar- | (C3) | (1) | 19.3 | 6.0 | — | — | 1.7 | 3.0 | 386.7 | — | | | | | | |
| ative | | | | | | | | | | | | | | | | |
| Example 3 | | | | | | | | | | | | | | | | |
| Example 28 | (28) | (2) | 4.6 | 4.0 | — | — | 0.4 | 1.0 | 92.1 | 14.7 | 2.0 | — | — | 1.3 | 2.0 | 294.6 |
| Example 29 | (29) | (1) | 4.6 | 4.0 | — | — | 0.4 | 1.0 | 92.1 | 14.7 | 2.0 | — | — | 1.3 | 2.0 | 294.6 |
| Example 30 | (30) | (1) | 4.6 | 4.0 | — | — | 0.4 | 1.0 | 92.1 | 14.7 | 2.0 | — | — | 1.3 | 2.0 | 294.6 |
| Example 31 | (31) | (1) | 4.6 | 4.0 | — | — | 0.4 | 1.0 | 92.1 | 14.7 | 2.0 | — | — | 1.3 | 2.0 | 294.6 |
| Example 32 | (32) | (1) | 4.6 | 4.0 | — | — | 0.4 | 1.0 | 92.1 | 14.7 | 2.0 | — | — | 1.3 | 2.0 | 294.6 |
| Example 33 | (33) | (1) | 4.6 | 4.0 | — | — | 0.4 | 1.0 | 92.1 | 14.7 | 2.0 | — | — | 1.3 | 2.0 | 294.6 |
| Example 34 | (34) | (1) | 4.6 | 4.0 | — | — | 0.4 | 1.0 | 92.1 | 14.7 | 2.0 | — | — | 1.3 | 2.0 | 294.6 |
| Example 35 | (35) | (1) | 4.6 | 4.0 | — | — | 0.4 | 1.0 | 92.1 | 14.7 | 2.0 | — | — | 1.3 | 2.0 | 294.6 |
| Example 36 | (36) | (1) | 4.6 | 4.0 | — | — | 0.4 | 1.0 | 92.1 | 14.7 | 2.0 | — | — | 1.3 | 2.0 | 294.6 |
| Example 37 | (37) | (1) | 4.6 | 4.0 | — | — | 0.4 | 1.0 | 92.1 | 14.7 | 2.0 | — | — | 1.3 | 2.0 | 294.6 |
| Example 38 | (38) | (1) | 4.6 | 4.0 | — | — | 0.4 | 1.0 | 92.1 | 14.7 | 2.0 | — | — | 1.3 | 2.0 | 294.6 |
| Example 39 | (39) | (1) | 4.6 | 4.0 | — | — | 0.4 | 1.0 | 92.1 | 14.7 | 2.0 | — | — | 1.3 | 2.0 | 294.6 |
| Example 40 | (40) | (3) | 4.6 | 4.0 | — | — | 0.4 | 1.0 | 92.1 | 14.7 | 2.0 | — | — | 1.3 | 2.0 | 294.6 |
| Compar- | (C4) | (1) | 4.6 | 4.0 | — | — | 0.4 | 1.0 | — | 14.7 | 2.0 | — | — | 1.3 | 2.0 | — |
| ative | | | | | | | | | | | | | | | | |
| Example 4 | | | | | | | | | | | | | | | | |

| | | | | | | | | | | |
|---|---|---|---|---|---|---|---|---|---|---|
| Compar- | (C5) | (1) | 19.3 | 6.0 | — | — | 1.7 | 3.0 | 386.7 | — |
| ative | | | | | | | | | | |
| Example 5 | | | | | | | | | | |

TABLE 2

| | Content of resin particles | | Inorganic particles | | | Resin particles | | | | | | |
|---|---|---|---|---|---|---|---|---|---|---|---|---|
| | First | Second | | Particle | | | Particle | | | | Particle | Image |
| | layer | layer | | size | | | size | Element ratio | | | size ratio | density |
| | (inside) | (outside) | Type | D1 | Content | Type | D2 | A | B | B − A | D1/D2 | stability |
| | % by mass | % by mass | — | nm | % by mass | — | nm | atm % | | | — | — |
| Example 1 | 40 | 10 | (S1) | 12 | 20 | (M1) | 250 | 3.5 | 5.3 | 1.8 | 0.048 | A |
| Example 2 | 38 | 10 | (S1) | 12 | 20 | (M1) | 250 | 3.5 | 4.7 | 1.2 | 0.048 | A |
| Example 3 | 36 | 10 | (S1) | 12 | 20 | (M1) | 250 | 3.5 | 4.5 | 1.0 | 0.048 | B |
| Example 4 | 34 | 10 | (S1) | 12 | 20 | (M1) | 250 | 3.5 | 4.3 | 0.8 | 0.048 | C |
| Example 5 | 32 | 10 | (S1) | 12 | 20 | (M1) | 250 | 3.5 | 4.0 | 0.5 | 0.048 | D |
| Example 6 | 42 | 10 | (S1) | 12 | 20 | (M1) | 250 | 3.5 | 5.8 | 2.3 | 0.048 | A |
| Example 7 | 44 | 10 | (S1) | 12 | 20 | (M1) | 250 | 3.5 | 6.0 | 2.5 | 0.048 | B |
| Example 8 | 46 | 10 | (S1) | 12 | 20 | (M1) | 250 | 3.5 | 6.2 | 2.7 | 0.048 | C |
| Example 9 | 48 | 10 | (S1) | 12 | 20 | (M1) | 250 | 3.5 | 6.5 | 3.0 | 0.048 | D |
| Comparative | 30 | 10 | (S1) | 12 | 20 | (M1) | 250 | 3.5 | 3.9 | 0.4 | 0.048 | E |
| Example 1 | | | | | | | | | | | | |
| Comparative | 50 | 10 | (S1) | 12 | 20 | (M1) | 250 | 3.5 | 6.6 | 3.1 | 0.048 | E |
| Example 2 | | | | | | | | | | | | |
| Example 10 | 33 | 3 | (S1) | 12 | 20 | (M1) | 250 | 1.6 | 3.4 | 1.8 | 0.048 | C |
| Example 11 | 35 | 5 | (S1) | 12 | 20 | (M1) | 250 | 1.7 | 3.5 | 1.8 | 0.048 | B |
| Example 12 | 37 | 7 | (S1) | 12 | 20 | (M1) | 250 | 2.5 | 4.3 | 1.8 | 0.048 | B+ |
| Example 13 | 39 | 9 | (S1) | 12 | 20 | (M1) | 250 | 3.0 | 4.8 | 1.8 | 0.048 | A |
| Example 14 | 42 | 12 | (S1) | 12 | 20 | (M1) | 250 | 6.0 | 7.8 | 1.8 | 0.048 | A |
| Example 15 | 44 | 14 | (S1) | 12 | 20 | (M1) | 250 | 8.0 | 9.8 | 1.8 | 0.048 | B+ |
| Example 16 | 46 | 16 | (S1) | 12 | 20 | (M1) | 250 | 10.2 | 12.0 | 1.8 | 0.048 | B |
| Example 17 | 48 | 18 | (S1) | 12 | 20 | (M1) | 250 | 11.0 | 12.8 | 1.8 | 0.048 | C |
| Example 18 | 40 | 10 | (Sn) | 12 | 20 | (M1) | 250 | 3.5 | 5.3 | 1.8 | 0.048 | B |
| Example 19 | 40 | 10 | (A) | 22 | 20 | (M1) | 250 | 3.5 | 5.3 | 1.8 | 0.088 | B |
| Example 20 | 40 | 10 | (T) | 20 | 20 | (M1) | 250 | 3.5 | 5.3 | 1.8 | 0.080 | B |
| Example 21 | 40 | 10 | (S2) | 22 | 20 | (M1) | 250 | 3.2 | 5.0 | 1.8 | 0.088 | B+ |
| Example 22 | 40 | 10 | (S3) | 12 | 20 | (M1) | 250 | 2.5 | 4.3 | 1.8 | 0.048 | B |
| Example 23 | 40 | 10 | (S1) | 12 | 14 | (M1) | 250 | 3.5 | 5.3 | 1.8 | 0.048 | C |
| Example 24 | 40 | 10 | (S1) | 12 | 15 | (M1) | 250 | 3.5 | 5.3 | 1.8 | 0.048 | B |
| Example 25 | 40 | 10 | (S1) | 12 | 35 | (M1) | 250 | 3.5 | 5.3 | 1.8 | 0.048 | B |
| Example 26 | 40 | 10 | (S1) | 12 | 37 | (M1) | 250 | 3.5 | 5.3 | 1.8 | 0.048 | C |
| Example 27 | 40 | 10 | (S1) | 12 | 20 | — | — | 4.8 | 5.3 | 0.5 | — | D |
| Comparative | 20 | 0 | (S1) | 12 | 20 | (M1) | 250 | 8.0 | 8.0 | 0.0 | 0.048 | E |
| Example 3 | | | | | | | | | | | | |
| Example 28 | 40 | 10 | (S1) | 12 | 20 | (M1) | 250 | 3.2 | 4.8 | 1.6 | 0.048 | B+ |
| Example 29 | 40 | 10 | (S1) | 12 | 20 | (M2) | 70 | 3.5 | 4.4 | 0.9 | 0.171 | C |
| Example 30 | 40 | 10 | (S1) | 12 | 20 | (M3) | 100 | 3.5 | 4.6 | 1.1 | 0.120 | B |
| Example 31 | 40 | 10 | (S1) | 12 | 20 | (A1) | 150 | 3.5 | 5.1 | 1.6 | 0.080 | A |
| Example 32 | 40 | 10 | (S1) | 12 | 20 | (A2) | 350 | 3.5 | 5.4 | 1.9 | 0.034 | A |
| Example 33 | 40 | 10 | (S1) | 12 | 20 | (M4) | 400 | 3.5 | 5.5 | 2.0 | 0.030 | A |
| Example 34 | 40 | 10 | (S1) | 12 | 20 | (M5) | 900 | 3.3 | 5.7 | 2.4 | 0.013 | B |
| Example 35 | 40 | 10 | (S4) | 7 | 20 | (M5) | 900 | 3.3 | 5.9 | 2.6 | 0.008 | C |
| Example 36 | 40 | 10 | (S7) | 65 | 20 | (M4) | 400 | 3.7 | 4.4 | 0.7 | 0.163 | D |
| Example 37 | 40 | 10 | (S4) | 7 | 20 | (A1) | 150 | 3.3 | 5.3 | 2.0 | 0.047 | A |
| Example 38 | 40 | 10 | (S5) | 30 | 20 | (A2) | 350 | 3.5 | 5.9 | 2.4 | 0.086 | B+ |
| Example 39 | 40 | 10 | (S6) | 40 | 20 | (M4) | 400 | 3.6 | 6.2 | 2.6 | 0.100 | B |
| Example 40 | 40 | 10 | (S1) | 12 | 20 | (M1) | 250 | 3.2 | 4.7 | 1.5 | 0.048 | B |
| Comparative | 40 | 10 | (S1) | 12 | 20 | (M1) | 250 | 3.5 | 3.5 | 0.0 | 0.048 | E |
| Example 4 | | | | | | | | | | | | |
| Comparative | 20 | 0 | (S7) | 65 | 20 | (M1) | 250 | 8.2 | 8.2 | 0.0 | 0.260 | E |
| Example 5 | | | | | | | | | | | | |

As shown in Table 2, the carriers and developers of Examples 1 to 40 are more excellent in image density stability than the carriers and developers of Comparative Examples 1 to 5.

The electrostatic charge image developing carrier, the electrostatic charge image developer, the process cartridge, the image forming apparatus, and the image forming method according to the present disclosure include the following aspects.

### Supplementary Notes

(((1))) An electrostatic charge image developing carrier comprising:
magnetic particles; and
a resin coating layer that coats the magnetic particles,
wherein the resin coating layer contains inorganic particles, and
in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less.

(((2))) The electrostatic charge image developing carrier according to (((1))),
wherein the inorganic particles are at least one selected from the group consisting of silica particles, titania particles, and alumina particles.

(((3))) The electrostatic charge image developing carrier according to (((1))) or (((2))),
wherein the inorganic particles are silica particles.

(((4))) The electrostatic charge image developing carrier according to any one of (((1))) to (((3))),
wherein the inorganic particles are inorganic particles subjected to a surface treatment.

(((5))) The electrostatic charge image developing carrier according to any one of (((1))) to (((3))),
wherein the inorganic particles are inorganic particles having a surface subjected to a hydrophobization treatment.

(((6))) The electrostatic charge image developing carrier according to any one of (((1))) to (((5))),
wherein a content of the inorganic particles in the resin coating layer is 15% by mass or more and 35% by mass or less with respect to a total mass of the resin coating layer.

(((7))) The electrostatic charge image developing carrier according to any one of (((1))) to (((6))),
wherein a value of B is 3.5 atm % or more and 12.0 atm % or less.

(((8))) The electrostatic charge image developing carrier according to any one of (((1))) to (((7))),
wherein a value of A is 2.0 atm % or more and 10.0 atm % or less.

(((9))) The electrostatic charge image developing carrier according to any one of (((1))) to (((8))),
wherein the value of B−A is 1.2 atm % or more and 2.3 atm % or less.

(((10))) The electrostatic charge image developing carrier according to any one of (((1))) to (((9))),
wherein the resin coating layer further contains resin particles, and
a value of a ratio D1/D2 of an average primary particle size D1 of the inorganic particles contained in the resin coating layer to an average primary particle size D2 of the resin particles is 0.01 or more and 0.15 or less.

(((11))) The electrostatic charge image developing carrier according to any one of (((1))) to (((10))),
wherein the resin coating layer further contains resin particles, and
an average primary particle size D2 of the resin particles contained in the resin coating layer is 100 nm or more and 400 nm or less.

(((12))) An electrostatic charge image developer comprising:
the electrostatic charge image developing carrier according to any one of (((1))) to (((11))); and
a toner.

(((13))) A process cartridge comprising:
a developing device that contains the electrostatic charge image developer according to (((12))) and develops an electrostatic charge image formed on a surface of an image holder as a toner image using the electrostatic charge image developer,
wherein the process cartridge is detachable from an image forming apparatus.

(((14))) An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to (((12))) and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

(((15))) An image forming method comprising:
charging a surface of an image holder;
forming an electrostatic charge image on the charged surface of the image holder;
developing the electrostatic charge image formed on the surface of the image holder as a toner image using the electrostatic charge image developer according to (((12)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing carrier comprising:
magnetic particles; and
a resin coating layer that coats the magnetic particles,
wherein the resin coating layer contains inorganic particles, and
in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less.

2. The electrostatic charge image developing carrier according to claim 1,
wherein the inorganic particles are at least one selected from the group consisting of silica particles, titania particles, and alumina particles.

3. The electrostatic charge image developing carrier according to claim 1,
wherein the inorganic particles are silica particles.

4. The electrostatic charge image developing carrier according to claim 1,
wherein the inorganic particles are inorganic particles subjected to a surface treatment.

5. The electrostatic charge image developing carrier according to claim 2,
wherein the inorganic particles are inorganic particles subjected to a surface treatment.

6. The electrostatic charge image developing carrier according to claim 1,
wherein the inorganic particles are inorganic particles having a surface subjected to a hydrophobization treatment.

7. The electrostatic charge image developing carrier according to claim 2,
wherein the inorganic particles are inorganic particles having a surface subjected to a hydrophobization treatment.

8. The electrostatic charge image developing carrier according to claim 1,
wherein a content of the inorganic particles in the resin coating layer is 15% by mass or more and 35% by mass or less with respect to a total mass of the resin coating layer.

9. The electrostatic charge image developing carrier according to claim 2,
wherein a content of the inorganic particles in the resin coating layer is 15% by mass or more and 35% by mass or less with respect to a total mass of the resin coating layer.

10. The electrostatic charge image developing carrier according to claim 1,
wherein a value of B is 3.5 atm % or more and 12.0 atm % or less.

11. The electrostatic charge image developing carrier according to claim 2,
wherein a value of B is 3.5 atm % or more and 12.0 atm % or less.

12. The electrostatic charge image developing carrier according to claim 1,
wherein a value of A is 2.0 atm % or more and 10.0 atm % or less.

13. The electrostatic charge image developing carrier according to claim 2,
wherein a value of A is 2.0 atm % or more and 10.0 atm % or less.

14. The electrostatic charge image developing carrier according to claim 1,
wherein the value of B−A is 1.2 atm % or more and 2.3 atm % or less.

15. The electrostatic charge image developing carrier according to claim 1,
wherein the resin coating layer further contains resin particles, and
a value of a ratio D1/D2 of an average primary particle size D1 of the inorganic particles contained in the resin coating layer to an average primary particle size D2 of the resin particles is 0.01 or more and 0.15 or less.

16. The electrostatic charge image developing carrier according to claim 15,
wherein the resin coating layer further contains resin particles, and
an average primary particle size D2 of the resin particles contained in the resin coating layer is 100 nm or more and 400 nm or less.

17. An electrostatic charge image developer comprising:
the electrostatic charge image developing carrier according to claim 1; and
a toner.

18. A process cartridge comprising:
a developing device that contains the electrostatic charge image developer according to claim 17 and develops an electrostatic charge image formed on a surface of an image holder as a toner image using the electrostatic charge image developer,
wherein the process cartridge is detachable from an image forming apparatus.

19. An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to claim 17 and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image using the electrostatic charge image developer according to claim 17;
transferring the toner image formed on the surface of the image holder to a surface of a recording medium; and
fixing the toner image transferred to the surface of the recording medium.
